(19) United States
(12) Patent Application Publication
(10) Pub. No.: US 2026/0183976 A1
(43) Pub. Date: Jul. 2, 2026

(54) PENKNIFE UNFOLDING ACCESSORY

(71) Applicant: Cynthia H. Claiborne, Bellevue, WA (US)

(72) Inventor: Cynthia H. Claiborne, Bellevue, WA (US)

(21) Appl. No.: 19/001,889

(22) Filed: Dec. 26, 2024

(51) Int. Cl. B26B 1/02; B26B 11/00

(52) U.S. Cl. CPC B26B 1/02; B26B 11/001

(57) ABSTRACT

A penknife unfolding accessory comprises an envelope or sheath of sheet material which wraps around a penknife blade, extending beyond the folded blade to provide an area for gripping and unfolding the blade. To prepare for use, the envelope is wrapped around an open blade which is then folded into the penknife, leaving an area of envelope protruding from the penknife. In use, the protruding area is grasped and pulled by a user to unfold and open the blade.

### BACKGROUND OF THE INVENTION

### Field of the Invention

This invention relates to penknives. More specifically, this invention relates to an article for unfolding blades that are folded in a penknife.

### Description of the Related Art

Penknives with folding blades are a common tool, affording safe and easy transport of blades of various configurations which, when unfolded, provide various utilities. Penknife blades commonly have a small notch or groove on the blade, also known as the nail nick. Such blades are opened from a closed position within the penknife by holding the knife firmly in one hand and, using the thumb or fingernail of the other hand, pulling the blade out using the nail nick, unfolding and opening the blade until the blade is locked in place if, as if often the case, the blade has a locking mechanism.

A common problem in using a standard penknife is that the amount of force needed to open the blade from a folded position is such that undue stress is applied to a fingernail engaged with the nail nick, presenting the risk of damage to the nail. When the user has fashion or custom nails, the risk of aesthetic or physical damage to the nail is highly significant. What is needed is a solution providing the utility of unfolding a blade from a penknife without risking damage to fingernails. What is needed further is such a solution that is adaptable to a wide variety of penknife blades and configurations. Further, it is desirable that such a solution be simple to use and inexpensive to manufacture.

### SUMMARY OF THE INVENTION

A penknife unfolding accessory comprises an envelope or sheath of sheet material which wraps around a penknife blade, extending beyond the folded blade to provide an area for gripping and unfolding the blade. Embodiments are fabricated of flexible but tough plastic sheet, folded in half and configured to engage the working edge of a blade along the fold, with the edges of the sheet distal from the fold protruding from the penknife when the engaged blade is closed. In use, the area of the sheet protruding from the penknife is grasped and pulled by a user to unfold and open the blade. Embodiments may reinforce the area of the fold with thicker or additional material to protect the sheet from damage by the working edge of a blade. Embodiments may also provide configuration of the sheet in the form of ridges or other shaping of the protruding portion of the sheet to afford a better grasp for the user.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1a is an elevation view of the side of an embodiment of the invention;

FIG. 1b is an elevation view of the front of an embodiment of the invention;

FIG. 2 depicts an exemplary penknife having six blades, all partially opened, two of the blades portrayed engaged with embodiments of the invention;

FIG. 3 depicts a folded penknife having one embodiment of the invention engaged with each of two folded blades; and

FIG. 4 depicts use of an embodiment of the invention to unfold a blade of the knife depicted in FIG. 3.

### DETAILED DESCRIPTION OF THE INVENTION

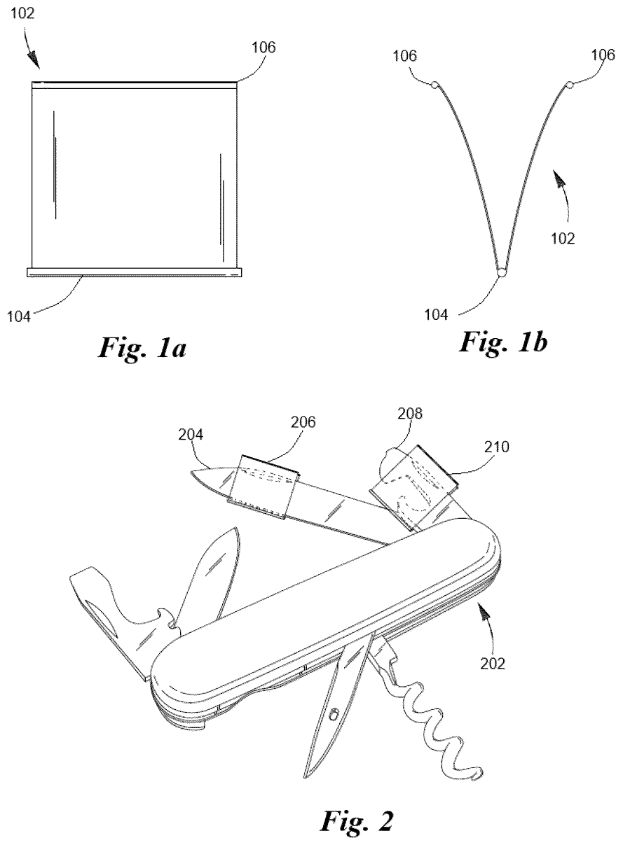

Turning now to the drawings, FIGS. 1a and 1b illustrate an embodiment of the invention. The penknife accessory comprises an envelope 102 of sheet material folded in half. In some embodiments, the sheet material of envelope 102 is thicker at the fold 104, to provide protection of the sheet from the working edge of a knife blade. Embodiments may additionally have raised portions 106 at the edge, to afford gripping the envelope in use. Alternatively or in addition, in some embodiments the portions of envelope 102 at least proximal the edge may be corrugated, ridged, dimpled or otherwise formed, providing means further to enhance gripping of the envelope. All such means, while not illustrated, are contemplated hereby.

Envelope 102 is comprised of tough but flexible sheet material such as high density polyethylene, polypropylene or polyethylene terephthalate glycol. Embodiments of the invention may be easily fabricated of such thermoplastics by hot extraction or by stamping, processes well known to those of skill in the art. Other embodiments may be fashioned of other materials, such as leather or nylon mesh. Furthermore, some embodiments employing one material for the sheet may employ a different, tougher if less flexible material, such as nylon, graphene or polycarbonate, adhering at the fold to provide further protection of the envelope from damage by the working edge of a blade. The present invention contemplates all such materials.

FIG. 2 depicts an exemplary penknife 202 having six blades, all partially opened, two of the blades portrayed engaged with embodiments of the invention. A first envelope 206 is wrapped around long knife blade 204 and second envelope 208 is wrapped around can opener blade 206. A user wraps the envelope of this invention around an open blade, then closes the blade so that the edges of the open end of the envelope extend beyond the folded blade.

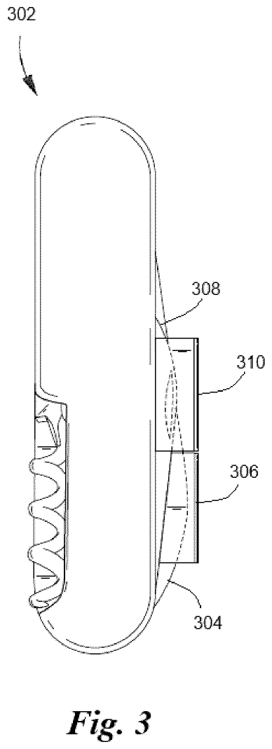

Turning to FIG. 3, a knife 302 is shown with folded foreground blade 308 with the protruding edges of its envelope 310 extending beyond the upper edge of blade 308. Similarly, folded background blade 304 has an envelope 306 with edges extending beyond its upper edge.

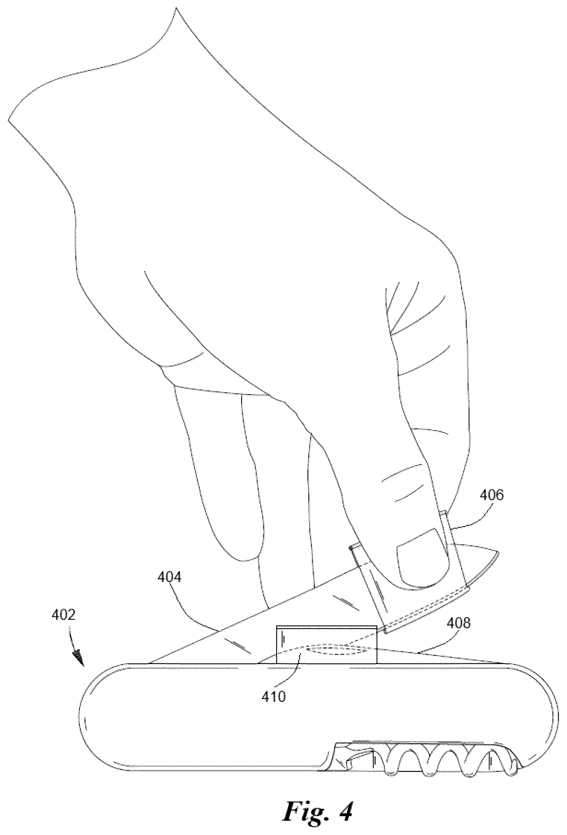

The utility of the invention is illustrated in FIG. 4. Here, a user unfolds large background blade 404 of penknife 402 by grasping envelope 406, pulling it outward from penknife 402 to unfold blade 404. Meanwhile, foreground blade 408 remains folded with its envelope 410 extending outward.

As a further utility, embodiments of the invention can enable a user to quickly locate and unfold a particular blade, by way of providing differing distinguishable envelopes for different blades. For example, but not by way of limitation, envelopes may be of different colors or different shapes. Alternatively, envelopes may have printing or other demarcation for distinctiveness. The present invention contemplates any and all such means of distinguishing envelopes.

Persons of skill in the art will recognize that embodiments of the penknife unfolding accessory of the present invention may vary widely in dimensions and still provide the needed utility. All that is required is that, when placed around a blade, the envelope will fit inside the penknife when the blade is folded, and further that enough of the envelope extends beyond a folded blade for a user to grasp in order easily to pull up and unfold the blade.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. A penknife unfolding accessory, comprising:
a sheet of tough, flexible material, the sheet configured to wrap around a blade of a penknife, said blade having a working edge and an outer edge, the sheet further divided by a fold configured for placement proximal the working edge of said blade, the sheet further having edges configured to extend beyond the outer edge of said blade when the fold is proximal the working edge of said blade.

2. The penknife unfolding accessory according to claim 1 comprised of a thermoplastic.

3. The penknife unfolding accessory according to claim2, wherein the thermoplastic consists of one of high density polyethylene, polypropylene and polyethylene terephthalate glycol.

4. The penknife unfolding accessory according to claim 1 comprised of leather.

5. The penknife unfolding accessory according to claim 1 comprised of nylon mesh.

6. The penknife unfolding accessory according to claim 1, further comprising means for enhancing grip on the edges of the sheet.

7. A method of unfolding a blade from a penknife, the blade having a working edge and an outer edge, the method comprising:
wrapping an envelope around the working edge of the blade with the blade open;
closing the blade, and
holding the penknife firmly in one hand and grasping the envelope with the other hand, pulling the envelope to unfold the blade.
